(19) United States
(12) Patent Application Publication
(10) Pub. No.: US 2016/0277997 A1
(43) Pub. Date: Sep. 22, 2016

(54) VEHICLE, COMMUNICATION METHOD, AND WIRELESS COMMUNICATION APPARATUS INCLUDED THEREIN

(71) Applicant: HYUNDAI MOTOR COMPANY, Seoul (KR)

(72) Inventors: Kyunghyun KANG, Suwon-si (KR); Ki Dong KANG, Seoul (KR); Heejin RO, Seoul (KR); Seok-young YOUN, Seoul (KR); Sung Un KIM, Yongin-si (KR); Bitna BAEK, Seoul (KR); Ga Hee KIM, Suwon-si (KR); Jong Hyuck HEO, Yongin-si (KR); Chisung KIM, Seoul (KR)

(21) Appl. No.: 14/957,547

(22) Filed: Dec. 2, 2015

(30) Foreign Application Priority Data
Mar. 19, 2015 (KR) 10-2015-0038477

(51) Int. Cl. H04W 40/22; H04W 76/02

(52) U.S. Cl. CPC H04W 40/22; H04W 76/023

(57) ABSTRACT

A vehicle includes a wireless communication unit for performing communication with an external device through a first communication link established with a base station, and a controller for controlling, if a shadow area is detected, the wireless communication unit to establish a second communication link with the base station through a multi-hop wireless network established with another vehicle existing around the vehicle.

### CROSS-REFERENCE TO RELATED APPLICATION

This application claims the benefit of priority to Korean Patent Application No. 10-2015-0038477, filed on Mar. 19, 2015 with the Korean Intellectual Property Office, the disclosure of which is incorporated herein by reference.

### TECHNICAL FIELD

Embodiments of the present disclosure relate to a vehicle, a communication method, and a wireless communication apparatus included therein, and more particularly, to a vehicle capable of communicating with other vehicles, a communication method of the vehicle, and a wireless communication apparatus included in the vehicle.

### BACKGROUND

A vehicle is a means of transportation that runs on a road or a rail using fossil fuel or electricity as a power source.

Many vehicles include an audio system and a video system to allow a driver to listen to the music and watch videos during driving, in addition to a including a function of transporting goods or persons, and also, may include a navigation system to display a route to the driver's destination.

Lately, a need for a vehicle to communicate with external devices is increasing. For example, a navigation function to guide a vehicle to a destination needs information about traffic situations in order to seek an optimal route. However, since such traffic situations change frequently, a vehicle needs to acquire information about traffic situations in real time.

### SUMMARY OF THE DISCLOSURE

Therefore, it is an aspect of the present disclosure to provide a vehicle including a wireless communication apparatus for communicating with another vehicle, an external terminal, or a wireless communication base station, and a method of controlling the vehicle.

Additional aspects of the disclosure will be set forth in part in the description which follows and, in part, will be obvious from the description, or may be learned by practice of the disclosure.

In accordance with one aspect of the present disclosure, a vehicle includes: a wireless communication unit configured to perform communication with an external device through a first communication link established with a base station; and a controller configured to control, if a shadow area is detected, the wireless communication unit to establish a second communication link with the base station through a multi-hop wireless network established with another vehicle existing around the vehicle.

The location information of the shadow area may be received from an external server.

The location information of the shadow area may be stored in advance in the AVN system.

The vehicle may further include an Audio/Video/Navigation (AVN) system configured to acquire location information of the shadow area, wherein the controller may determine whether the shadow area is located on a driving path of the vehicle, based on the location information of the shadow area received from the AVN system.

The controller may determine whether the shadow area is located on a driving path of the vehicle, based on information related to the shadow area received from another vehicle running ahead through the wireless communication unit.

The controller may determine that the vehicle is located within the shadow area, if the intensity of a radio signal received from the base station is smaller than a predetermined reference value.

If the shadow area is detected, the controller may control the wireless communication unit to request the other vehicle existing around the vehicle to perform Device-to-Device (D2D) communication.

The controller may control the wireless communication unit to establish a multi-hop wireless network using the D2D communication.

The controller may establish the first communication link with the base station if the intensity of a radio signal received from the base station is greater than a predetermined reference value.

In accordance with another aspect of the present disclosure, a communication method of a vehicle includes: performing communication with an external device through a first communication link established with a base station; detecting a shadow area; and establishing, if the shadow area is detected, a second communication link with the base station through a multi-hop wireless network established with another vehicle existing around the vehicle.

The detecting of the shadow area may include determining whether the shadow area is located on a driving path of the vehicle, based on location information of the shadow area received from an Audio/Video/Navigation (AVN) system storing the location information of the shadow area.

The detecting of the shadow area may include determining whether the shadow area is located on a driving path of the vehicle, based on information related to the shadow area received from another vehicle running ahead through the wireless communication unit.

The detecting of the shadow area may include determining that the vehicle is located within the shadow area, if the intensity of a radio signal received from the base station is smaller than a predetermined reference value.

The establishing of the second communication link with the base station may include requesting, if the shadow area is detected, the other vehicle existing around the vehicle to perform Device-to-Device (D2D) communication.

The establishing of the second communication link with the base station may further include establishing a multi-hop wireless network using the D2D communication.

The communication method may further include establishing the first communication link with the base station if the intensity of a radio signal received from the base station is greater than a predetermined reference value.

In accordance with another aspect of the present disclosure, a wireless communication apparatus for vehicle includes: a wireless communication unit configured to perform communication with an external device through a first communication link established with a base station; and a controller configured to control, if a shadow area is detected, the wireless communication unit to establish a second communication link with the base station through a multi-hop wireless network established with another vehicle existing around the vehicle.

The controller may determine whether the shadow area is located on a driving path of the vehicle, based on location information of the shadow area received from an Audio/Video/Navigation (AVN) system acquiring the location information of the shadow area.

The location information of the shadow area may be received from an external server.

The location information of the shadow area may be stored in advance in the AVN system.

The controller may determine whether the shadow area is located on a driving path of the vehicle, based on information related to the shadow area received from another vehicle running ahead through the wireless communication unit.

The controller may determine that the vehicle is located within the shadow area, if the intensity of a radio signal received from the base station is smaller than a predetermined reference value.

If the shadow area is detected, the controller may control the wireless communication unit to request the other vehicle existing around the vehicle to perform Device-to-Device (D2D) communication.

The controller may control the wireless communication unit to establish a multi-hop wireless network using the D2D communication.

The controller may establish the first communication link with the base station, if the intensity of a radio signal received from the base station is greater than a predetermined reference value.

According to an aspect of the present disclosure as described above, there are provided a vehicle including a wireless communication apparatus for communicating with another vehicle, an external terminal, or a wireless communication base station, and a method of controlling the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows an external appearance of a vehicle according to an embodiment of the present disclosure;

FIG. 2 shows an interior of a vehicle according to an embodiment of the present disclosure;

FIG. 3 is a block diagram for describing various electronic devices included in a vehicle according to an embodiment of the present disclosure;

FIG. 4 is a block diagram of a wireless communication apparatus included in a vehicle according to an embodiment of the present disclosure;

FIGS. 5, 6A, 6B, and 6C are views for describing a 5Generation (5G) communication method;

FIG. 7 is a block diagram for describing a radio signal converting module included in a vehicle according to an embodiment of the present disclosure;

FIGS. 8 and 9 are flowcharts illustrating a method in which a vehicle according to an embodiment of the present disclosure establishes a multi-hop wireless network;

FIGS. 10A, 10B, and 10C are views for describing an example of establishing a multi-hop wireless network according to the method shown in FIGS. 8 and 9;

FIG. 11 is a flowchart illustrating an example of a communication method of a vehicle according to an embodiment of the present disclosure;

FIGS. 12, 13, 14, 15, and 16 are views for describing an example of establishing a multi-hop wireless network according to the communication method shown in FIG. 11;

FIG. 17 is a flowchart illustrating another example of a communication method of a vehicle according to an embodiment of the present disclosure; and

FIGS. 18 and 19 are views for describing an example of establishing a multi-hop wireless network according to the communication method shown in FIG. 17.

### DETAILED DESCRIPTION

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

Hereinafter, an embodiment of the present disclosure will be described in detail with reference to the accompanying drawings.

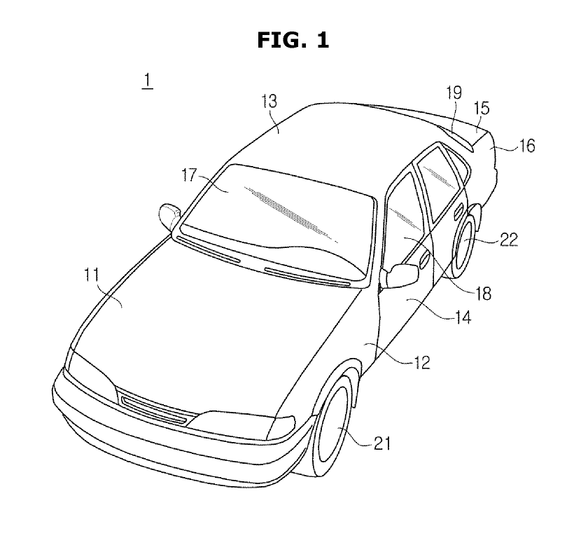

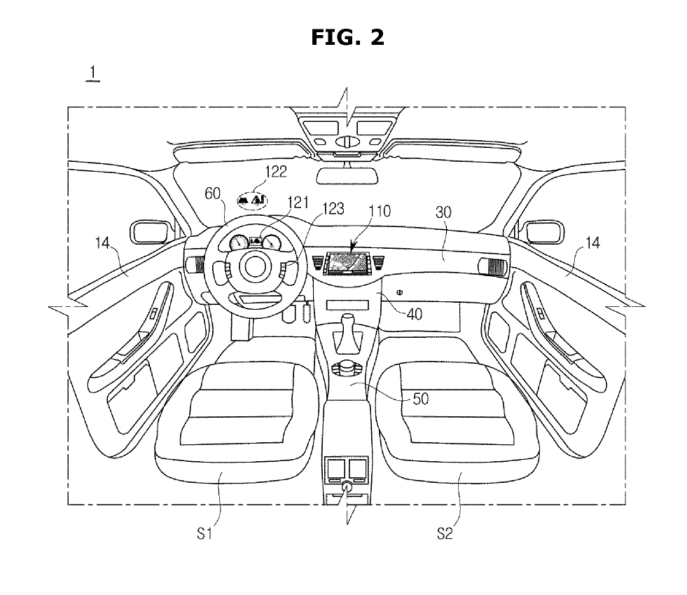

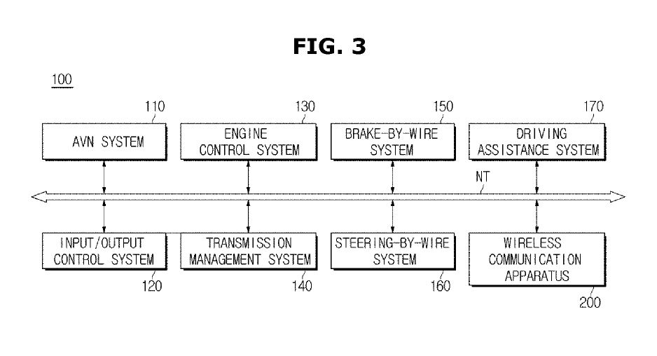

FIG. 1 shows an external appearance of a vehicle according to an embodiment of the present disclosure, FIG. 2 shows the interior of a vehicle according to an embodiment of the present disclosure, and FIG. 3 is a block diagram for describing various electronic devices included in a vehicle according to an embodiment of the present disclosure.

Referring to FIG. 1, a vehicle 1 according to an embodiment of the present disclosure may include a body forming an external appearance of the vehicle 1, a chassis (not shown) to support components of the vehicle 1, and a plurality of wheels 21 and 22 to move the body and the chassis.

The wheels 21 and 22 may include front wheels 21 provided in the front part of the vehicle 1, and rear wheels 22 provided in the rear part of the vehicle 1. The vehicle 1 may move forward or backward by rotations of the wheels 21 and 22.

The body may include a hood 11, front fenders 12, a roof panel 13, doors 14, a trunk lid 15, and quarter panels 16.

Also, the body may include a front window 17 (also referred to as a wind screen 17) provided in the front part, side windows 18 installed in the doors 14, and a rear window 19 provided in the rear part.

Referring to FIG. 2, in the inside of the body, a plurality of seats S1 and S2 in which passengers sit, a dash board 30 which controls operations of the vehicle 1 and on which various meters for displaying driving information of the vehicle 1 are provided, a center fascia 40 on which a control panel for allowing a user to manipulate attached devices included in the vehicle 1 is provided, a center console 50 in which a gear stick, a parking brake stick, and the like are provided, and a steering wheel 60 to enable a user to manipulate a heading direction of the vehicle 1 may be provided.

The seats S1 and S2 may allow a driver to manipulate the vehicle 1 at a comfortable, stable position, and may include a driver seat S1 in which the driver sits, a passenger seat S2 in which a passenger sits, and a back seat (not shown) that is provided in the back part inside the vehicle 1.

The dash board 30 may include various meters, such as a speedometer for displaying driving-related information, a fuel gauge, an automatic transmission selection lever lamp, a tachometer, and a trip meter.

The center fascia 40 may be positioned between the driver seat S1 and the passenger seat S2, and may include a manipulation unit for controlling an audio system, an air conditioner, and a heater, a ventilator of the air conditioner to adjust the inside temperature of the vehicle 1, and a cigar jack.

The center console 50 may be positioned below the center fascia 33 between the driver seat S1 and the passenger seat S2, and in the center console 50, a gear stick for shifting gears, a parking brake stick for parking, and the like, may be installed.

The steering wheel 60 may be attached on the dash board 30 in such a manner to be rotatable with respect to a steering axis. In order to change a heading direction of the vehicle 1, a driver may rotate the steering wheel 60 in a clockwise or counterclockwise direction.

The chassis (not shown) may include a power generating system (for example, an engine or a motor) that burns fuel to generate power for moving the vehicle 1, a fuel supplying system to supply fuel to the power generating system, a cooling system to cool the power generating system, an exhaust system to exhaust gas generated by burning fuel, a power transfer system to transfer power generated by the power generating system to the wheels 21 and 22, a steering system to transfer information about a heading direction of the vehicle 1 manipulated by the steering wheel 40 to the wheels 21 and 22, a brake system to stop rotating the wheels 21 and 22, and a suspension system to absorb vibrations of the wheels 21 and 22 according to road conditions.

The vehicle 1 may include various electronic devices 100, in addition to the above-described systems.

More specifically, referring to FIG. 3, the vehicle 1 may include an Audio/Video/Navigation (AVN) system 110, an input/output control system 120, an Engine Management System (EMS) 130, a Transmission Management System (TMS) 140, a brake-by-wire system 150, a steering-by-wire system 160, a driving assistance system 170, and a wireless communication apparatus 200. However, the electronic devices 100 shown in FIG. 3 are only a part of electronic devices included in the vehicle 1, and the vehicle 1 may further include other electronic devices.

Also, the electronic devices 100 included in the vehicle 1 may communicate with each other through a vehicle communication network NT. The vehicle communication network NT may adopt a communication standard, such as Media Oriented Systems Transport (MOST) having communication speed of maximally 24.5 Mbps (Mega-bits per second), FlexRay having communication speed of maximally 10 Mbps, Controller Area Network (CAN) having communication speed from 125 kbps (kilo-bits per second) to 1 Mbps, and Local Interconnect Network (LIN) having communication speed of 20 kbps. The vehicle communication network NT may adopt one or more communication standards of MOST, FlexRay, CAN, and LIN.

The AVN system 110 is a system to output audio or video according to a driver's control command. More specifically, the AVN system 110 may reproduce audio or video or guide a path to a destination, according to a drivers control command.

The input/output control system 120 may receive a driver's control command input through a button, and display information corresponding to the driver's control command. The input/output control system 120 may include a cluster display 121 mounted on the dash board 30 to display images, a Head-Up Display (HUD) 122 to project images on the wind screen 17, and a button module 123 installed in the steering wheel 60, as shown in FIGS. 1 and 2.

Referring to FIG. 2, the cluster display 121 may be disposed on the dash board 30 to display images. More specifically, the cluster display 121 may be disposed adjacent to the wind screen 17 so that a driver can acquire operation information of the vehicle 1, information about roads, or a driving route as long as the driver's eyeline does not greatly deviate from the front of the vehicle 1.

The cluster display 121 may comprise a Liquid Crystal Display (LCD) panel or an Organic Light Emitting Diode (OLED) panel.

The HUD 122 may project an image on the wind screen 17. The image projected on the wind screen 17 by the HUD 122 may include operation information of the vehicle 1, information about roads, or a driving route.

The EMS 130 may perform fuel injection control, fuel ratio feedback control, lean burn control, ignition timing control, and idle speed control. The EMS 130 may be a single system or a plurality of systems connected to each other through communication.

The TMS 140 may perform shift control, damper clutch control, pressure control upon turning on/off a friction clutch, and engine torque control during transmission. The TMS 140 may be a single system or a plurality of systems connected to each other through communication.

The brake-by-wire system 150 may control the brake of the vehicle 1. The brake-by-wire system 150 may include an Anti-lock Brake System (ABS).

The steering-by-wire system 160 may reduce a steering force upon low speed driving or parking, and increase a steering force upon high speed driving to thereby assist a driver's steering manipulations.

The driving assistance system 170 may assist driving of the vehicle 1, and may perform a front collision avoidance function, a lane departure warning function, a blind spot detection function, and a rear-view monitoring function.

The driving supporting system 170 may include a plurality of devices connected to each other through communication. For example, the driving assistance system 170 may include a Forward Collision Warning System (FCW) to sense a vehicle running ahead on the same lane to avoid collision with the vehicle, an Advanced Emergency Braking System (AEBS) to relieve, when collision with a front vehicle is unavoidable, the shock of the collision, an Adaptive Cruise Control (ACC) to sense a vehicle running ahead on the same lane to automatically accelerate/decelerate according to the speed of the vehicle, a Lane Departure Warning System (LDWS) to prevent departure from the driving lane, a Lane Keeping Assist System (LKAS) to control, if it is determined that the vehicle 1 departed from the driving lane, the vehicle 1 to return to the driving lane, a Blind Spot Detection (BSD) system to provide a driver with information about a vehicle located in a blind spot, and a Rear-end Collision Warning (RCW) system to sense a vehicle running behind on the same lane to avoid collision with the vehicle.

The wireless communication apparatus 200 may communicate with another vehicle, an external terminal, or a wireless communication base station. A configuration and operations of the wireless communication apparatus 200 will be described in detail, below.

The configuration of the vehicle 1 has been described above.

Hereinafter, a configuration and operations of the wireless communication apparatus 200 included in the vehicle 1 will be described.

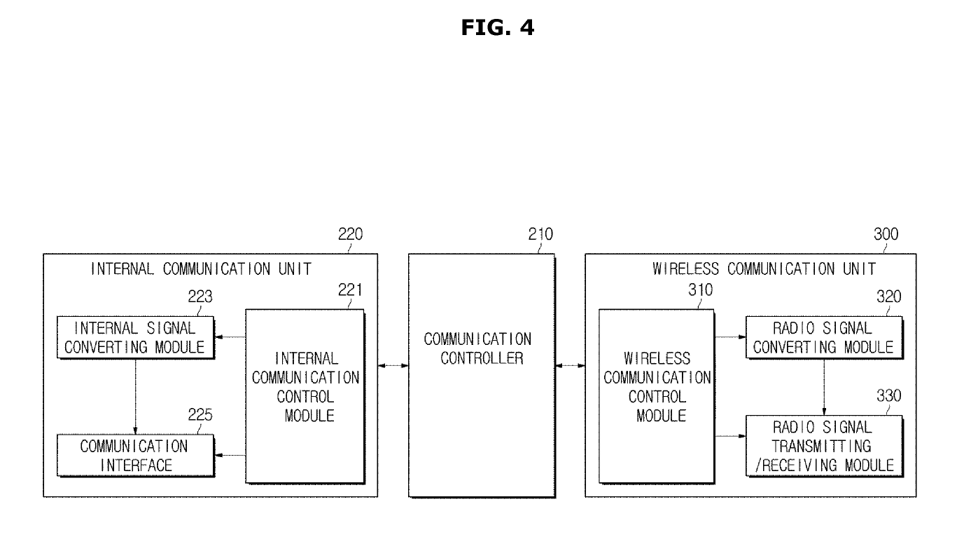

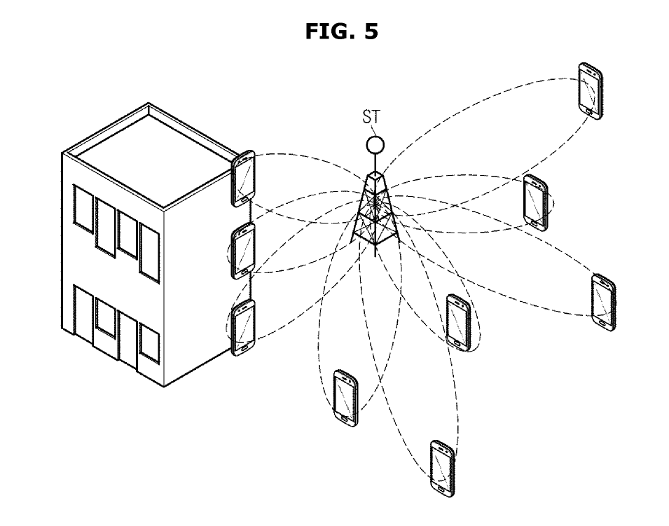

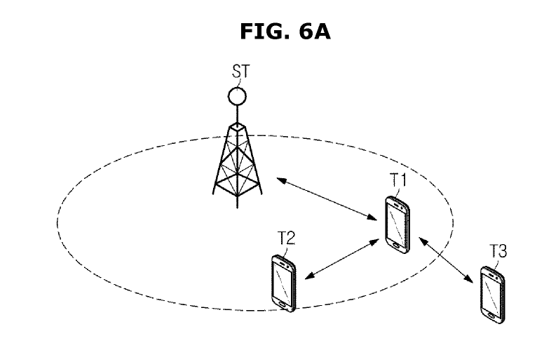

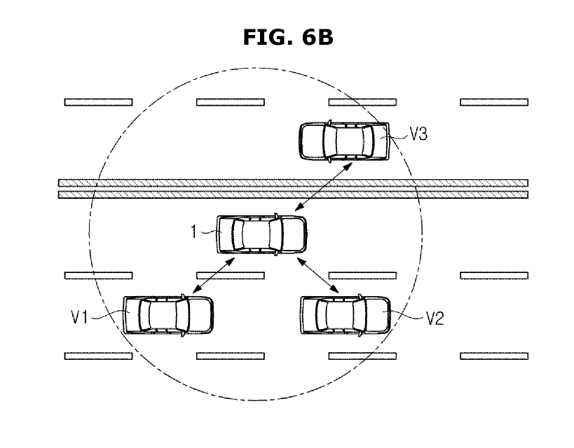

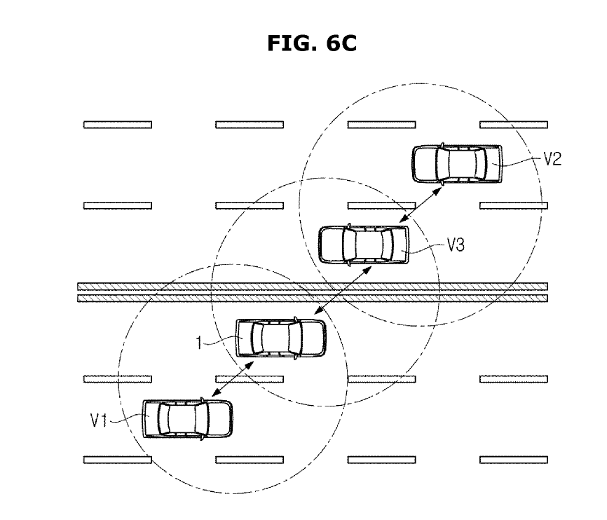

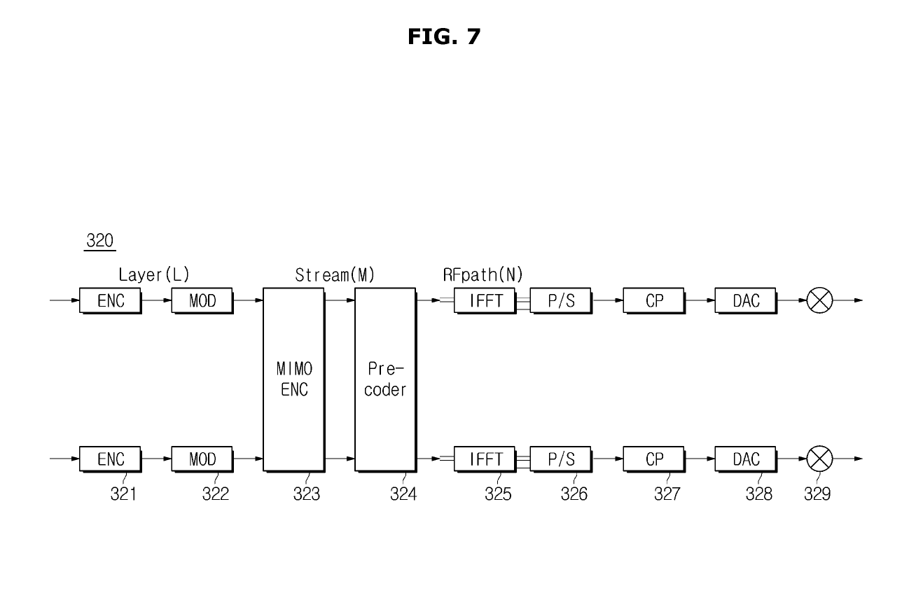

FIG. 4 is a block diagram of the wireless communication apparatus 200 included in the vehicle 1 according to an embodiment of the present disclosure, FIGS. 5, 6A, 6B, and 6C are views for describing a 5Generation (5G) communication method, and FIG. 7 is a block diagram for describing a radio signal converting module included in the vehicle 1 according to an embodiment of the present disclosure.

Referring to FIGS. 4, 5, 6A, 6B, 6C, and 7, the wireless communication apparatus 200 may include an internal communication unit 220 to communicate with various electronic devices 100 inside the vehicle 1 through a vehicle communication network NT, a wireless communication unit 300 to communicate with another vehicle, a mobile terminal, or a wireless communication base station, and a communication controller 210 to control operations of the internal communication unit 220 and the wireless communication unit 300.

The internal communication unit 220 may include an internal communication interface 225 to connect to the vehicle communication network NT, an internal signal converting module 223 to modulate/demodulate signals, and an internal communication control module 221 to control communications through the vehicle communication network NT. The internal communication interface 225 may receive communication signals transmitted from the various electronic devices 100 inside the vehicle 1 through the vehicle communication network NT, and transmit communication signals to the various electronic devices 100 inside the vehicle 1 through the vehicle communication network NT. Herein, the communication signals mean signals that are transmitted/received through the vehicle communication network NT.

The internal communication interface 225 may include a communication port to electrically connect the wireless communication apparatus 200 to the vehicle communication network NT, and a transceiver to transmit/receive signals.

The internal signal converting module 223 may demodulate a communication signal received through the internal communication interface 225 to a control signal, and modulate a digital control signal output from the communication controller 210 to an analog communication signal that is to be transmitted through the internal communication interface 223, under the control of the internal communication control module 221 which will be described below.

As described above, the communication signal means a signal that is transmitted/received through the vehicle communication network NT, and the control signal means a signal that is transmitted/received in the wireless communication apparatus 200. The format of the communication signal that is transmitted/received through the vehicle communication network NT may be different from that of the control signal that is transmitted/received between the internal communication unit 220 and the communication controller 210.

For example, in the case of the CAN, a communication signal may be transmitted through a pair of communication lines, and communication data “1” or “0” may be transmitted according to a potential difference between the pair of communication lines. In contrast, a control signal that is transmitted/received between the internal communication unit 220 and the communication controller 210 may be transmitted through a signal line, and control data “1” or “0” may be transmitted according to a potential of the single line.

As such, the internal signal converting module 223 may modulate a control signal received from the communication controller 210 to a communication signal according to the communication standard of the vehicle communication network NT, and also, demodulate a communication signal according to the communication standard of the vehicle communication network NT to a control signal that can be recognized by the communication controller 210.

The internal signal converting module 223 may include a memory to store data and a program for performing modulation/demodulation on communication signals, and a processor to perform modulation/demodulation on communication signals according to the program and data stored in the memory.

The internal communication control module 221 may control operations of the internal signal converting module 223 and the communication interface 225.

For example, when the internal communication control module 221 transmits a communication signal, the internal communication control module 221 may determine whether the vehicle communication network NT has been already occupied by another electronic device 100 through the communication interface 225, and control, if determining that the vehicle communication network NT is empty, the internal communication interface 225 and the internal signal converting module 223 to transmit a communication signal. Also, when the internal communication control module 221 receives a communication signal through the communication interface 225, the internal communication control module 221 may control the communication interface 225 and the internal signal converting module 223 to demodulate the received communication signal.

The internal communication control module 221 may include a memory to store data and a program for controlling the internal signal converting module 223 and the communication interface 225, and a processor to generate a control signal according to the program and data stored in the memory.

According to embodiments, the internal signal converting module 223 and the internal communication control module 221 may be implemented with separate memories and separate processors, or with a single memory and a single processor.

According to another embodiment, the internal communication control module 221 may be omitted. For example, the internal communication control module 221 may be integrated into the communication controller 210 which will be described below. In this case, the communication controller 210 can control signal transmission/reception of the internal communication control unit 221.

The wireless communication unit 300 may transmit/receive radio signals to/from another vehicle, a mobile terminal, or a wireless communication base station.

The wireless communication unit 300 may transmit/receive radio signals through one of various communication standards.

For example, the wireless communication unit 300 may adopt a 2Generation (2G) communication method including Time Division Multiple Access (TDMA) and Code Division Multiple Access (CDMA), a 3Generation (3G) communication method including Wide Code Division Multiple Access (WCDMA), Code Division Multiple Access 2000 (CDMA2000), Wireless Broadband (Wibro), and World Interoperability for Microwave Access (WiMAX), or a 4Generation (4G) communication method including Long Term Evolution (LTE) and Wireless Broadband Evolution. Also, the wireless communication unit 300 may adopt a 5Generation (5G) communication method.

The 4G communication method may use a frequency band of 2 GHz or less, whereas the 5G communication method can use a frequency band of about 28 GHz. However, the 5G communication method may use another frequency band.

In the 5G communication method, a large-scale antenna system may be used. The large-scale antenna system uses several tens of antennas to cover an ultra high frequency band and to simultaneously transmit/receive a large amount of data through multi-access. More specifically, the large-scale antenna system adjusts an arrangement of antenna elements to transmit/receive radio waves farther in a specific direction, thereby enabling massive transmission, and expanding an available area in a 5G communication network.

Referring to FIG. 5, a base station ST may transmit/receive data to/from many devices simultaneously through a large-scale antenna system. The large-scale antenna system may minimize transmission of radio waves in different directions from a direction in which radio waves should be transmitted to thus reduce noise, which leads to improvement in quality of transmission and reduction of energy.

Also, the 5G communication method may transmit, instead of transmitting transmission signals modulated through an Orthogonal Frequency Division Multiplexing (OFDM) method, radio signals modulated through a Non-Orthogonal Multiplexing Access (NOMA) method, thereby allowing multi-access of more devices while enabling massive transmission/reception.

For example, the 5G communication method can provide transmission speed of maximally 1 Gbps. Accordingly, the 5G communication method can support immersive communication requiring massive transmission to transmit/receive massive data, such as Ultra High Definition (UHD), 3D, and holograms. Accordingly, a user can use the 5G communication method to transmit/receive more delicate, immersive ultra-high capacity data at high speed.

Also, the 5G communication method may allow real-time processing having a maximum response speed of 1 ms or less. Accordingly, the 5G communication method can support real-time services responding to inputs before a user recognizes them. For example, a vehicle may receive sensor information from various devices even during driving and perform real-time processing on the sensor information to provide an autonomous driving system while providing various remote control. Also, the vehicle may use the 5G communication method to process sensor information related to other vehicles existing around the vehicle in real time to thereby provide a user with information about collision probability in real time while providing information about traffic situations of a driving path on which the vehicle runs in real time.

Also, through ultra real-time processing and massive transmission that are provided by the 5G communication method, the vehicle can provide a big data service to passengers in the vehicle. For example, the vehicle may analyze various web information or Social Network Service (SNS) information to provide customized information suitable for the situations of passengers in the vehicle. According to an embodiment, the vehicle may perform big data mining to collect information about restaurants or popular attractions around a driving path on which the vehicle runs to provide the collected information in real time, thereby enabling passengers to acquire various information about a region in which the vehicle runs.

Meanwhile, a 5G communication network can subdivide cells to support network densification and massive transmission. Herein, the cell means an area subdivided from a wide region in order to efficiently use frequencies for mobile communication. A low-power base station may be installed in each cell to support communication between terminals. For example, the 5G communication network may reduce the sizes of cells to further subdivide the cells so as to be configured as a 2-stage structure of macrocell base station-distributed small base station-communication terminal.

Also, in the 5G communication network, relay transmission of radio signals through a multi-hop method may be performed. For example, as shown in FIG. 6A, a first terminal T1 may relay a radio signal transmitted from a third terminal T3 located outside a network of a base station ST, to the base station ST. Also, the first terminal T1 may relay a radio signal transmitted from a second terminal T2 located inside the network of the base station ST, to the base station S. As described above, at least one device among devices that can use a 5G communication network may perform relay transmission through a multi-hop method, although the present disclosure is not limited to this. Accordingly, a region in which the 5G communication network is supported can be widened, and also, buffering occurring when there are too many users in a cell may be reduced.

Meanwhile, the 5G communication method can support Device-to-Device (D2D) communication that is applied to vehicles, wearable devices, and so on. The D2D communication, which is communication between devices, is used for a device to transmit/receive radio signals containing various stored data, as well as data sensed through sensors. According to the D2D communication, a device does not need to transmit/receive radio signals via a base station, and since radio signals are transmitted between devices, unnecessary energy consumption can be reduced. In order for a vehicle or a wearable device to use the 5G communication method, the corresponding device needs to have an antenna installed therein.

The vehicle may transmit/receive radio signals to/from other vehicles existing around the vehicle through D2D communication. For example, as shown in FIG. 6B, the vehicle 1 may perform D2D communication with other vehicles (that is, first, second, and third vehicles V1, V2, and V3) existing around the vehicle 1. Also, the vehicle 1 may perform D2D communication with a traffic signaling system (not shown) installed in intersections and the like.

According to another example, as shown in FIG. 6C, the vehicle 1 may transmit/receive radio signals to/from the first vehicle V1 and the third vehicle V3 through D2D communication, and the third vehicle V3 may transmit/receive radio signals to/from the vehicle 1 and the second vehicle V2 through D2D communication. In other words, a virtual network may be established between a plurality of vehicles 1, V1, V2, and V3 located within a range allowing D2D communication so as for the vehicles 1, V1, V2, and V3 to be able to transmit/receive radio signals therebetween.

Meanwhile, the 5G communication network may widen a region in which D2D communication is supported so that a device can perform D2D communication with another more distant device. Also, since the 5G communication network supports real-time processing having a response speed of 1 ms or less and high capacity communication of 1 Gbps or more, a running vehicle can transmit/receive signals containing desired data to/from another running vehicle through the 5G communication network.

For example, a vehicle can access other vehicles, various servers, systems, etc. around the vehicle in real time even during driving through the 5G communication method so as to transmit/receive data to/from the other vehicles, various servers, systems, etc. and to process the data to provide various services such as a navigation service through augmented reality.

Also, the vehicle may use another frequency band than the above-described frequency band to transmit/receive radio signals containing data via a base station or through D2D communication. The present disclosure is not limited to the communication method using the above-described frequency band.

In the following description, the wireless communication unit 300 (see FIG. 4) is assumed to adopt the 5G communication method.

As shown in FIG. 4, the wireless communication unit 300 may include a radio signal converting module 320 to modulate/demodulate signals, a radio signal transmitting/receiving module 330 to form a beam pattern for wireless communication and to transmit/receive radio signals through radio waves of the beam pattern, and a wireless communication control module 310 to control wireless communication.

The radio signal converting module 320 may demodulate a radio communication signal received through the radio signal transmitting/receiving module 330 to a control signal, and modulate a control signal output from the communication controller 210 to a radio communication signal that is to be transmitted through the radio signal transmitting/receiving module 330, under the control of the wireless communication control module 310 which will be described below.

The format of the radio communication signal that is transmitted/received through wireless communication may be different from that of the control signal in order to ensure reliability of wireless communication. Particularly, there is a great difference in that the radio communication signal is an analog signal and the control signal is a digital signal.

Also, the radio communication signal may be included in a carrier wave of a high frequency (for example, about 28 GHz in the 5G communication method) and transmitted. Accordingly, the radio signal converting module 320 may modulate a carrier wave according to a control signal output from the communication controller 210 to generate a communication signal, and demodulate a carrier wave received through an array antenna 340 to restore a control signal from a communication signal.

For example, the radio signal converting module 320 may include, as shown in FIG. 7, an encoder (ENC) 321, a modulator (MOD) 322, a Multiple Input Multiple Output (MIMO) encoder 323, a pre-coder 324, an Inverse Fast Fourier Transformer (IFFT) 325, a Parallel to Serial (P/S) converter 326, a Cyclic Prefix (CP) inserter 327, a Digital to Analog Converter (DAC) 328, and a frequency converter 329.

L control signals may be input to the MIMO encoder 323 through the encoder 321 and the modulator 322. M streams output from the MIMO encoder 323 may be pre-coded by the pre-coder 324 and converted into N pre-coded signals. The pre-coded signals may pass through the IFFT 325, the P/S converter 326, the CP inserter 327, and the DAC 328 and be then output as an analog signal. The analog signal output from the DAC 328 may be converted into a Radio Frequency (RF) band through the frequency converter 329.

The radio signal converting module 320 may include a memory to store data and a program for performing modulation/demodulation on communication signals, and a processor to perform modulation/demodulation on communication signals according to the data and program stored in the memory.

However, the radio signal converting module 320 is not limited to the configuration shown in FIG. 7, and may have another configuration according to a communication method.

The analog signal converted into the radio frequency band may be transferred to the radio signal transmitting/receiving module 330 (see FIG. 4).

The radio signal transmitting/receiving module 330 may receive a radio communication signal from an external device (for example, a terminal, a vehicle, or a base station) or transmit a radio communication signal to the external device, according to the control of the wireless communication control module 310 which will be described below.

The radio signal transmitting/receiving module 330 may include an antenna (not shown) that transmits electrical signals received through an electric line to free space.

Particularly, the radio signal transmitting/receiving module 330 may transmit/receive electric waves having a specific pattern according to the kind of the antenna. For example, if the radio signal transmitting/receiving module 330 includes a dipole antenna, the radio signal transmitting/receiving module 330 may transmit or receive electric waves omni-directionally. Also, if the radio signal transmitting/receiving module 330 includes an array antenna, the radio signal transmitting/receiving module 330 may form a beam pattern having directivity. As a result, the radio signal transmitting/receiving module 330 having the array antenna may transmit electric waves focused in a specific direction, and also receive electric waves transmitted in a specific direction.

The wireless communication control module 310 may control operations of the radio signal converting module 320 and the radio signal transmitting/receiving module 330.

For example, when communication with another vehicle, an external terminal, or an external base station is established, the wireless communication control module 310 may control the radio signal converting module 320 and the radio signal transmitting/receiving module 330 in order to estimate an optimal wireless communication channel. More specifically, the wireless communication control module 310 may estimate a wireless communication channel, and form an optimal wireless communication channel based on the result of the estimation.

The wireless communication control module 310 may include a memory to store data and a program for controlling the radio signal converting module 320 and the radio signal transmitting/receiving module 330, and a processor to generate control signals according to the data and program stored in the memory.

According to embodiments, the radio signal converting module 320 and the wireless communication control module 310 may be implemented with separate memories and separate processors, or with a single memory and a single processor.

According to another embodiment, the wireless communication control module 310 may be omitted. For example, the wireless communication control module 310 may be integrated into the communication controller 210 which will be described below. In this case, the communication controller 210 may control signal transmission/reception of the wireless communication unit 300.

The communication controller 210 may control operations of the internal communication unit 220 and the wireless communication unit 300. More specifically, if the communication controller 210 receives a signal through the internal communication unit 220, the communication controller 210 may interpret the received signal, and control operations of the internal communication unit 220 and the wireless communication unit 300 according to the result of the interpretation.

For example, if the communication controller 210 receives a data transmission request from another electronic device included in the vehicle 1 through the internal communication unit 220, the communication controller 210 may control the wireless communication unit 300 to transmit the corresponding data to another vehicle, an external terminal, or an external base station. Also, if the communication controller 210 receives data from another vehicle, an external terminal, or an external base station, the communication controller 210 may analyze the received data to determine a target device to which the data is to be transmitted, and control the internal communication unit 220 to transmit the received data to the target device.

Also, the communication controller 210 may request an external device to perform D2D communication in order to transmit a wireless communication signal through a multi-hop communication method.

The multi-hop communication method of the wireless communication apparatus 200 will be described in detail below.

The communication controller 210 may include a memory to store data and a program for controlling the internal communication unit 220 and the wireless communication unit 300, and a processor to generate control signals according to the data and program stored in the memory.

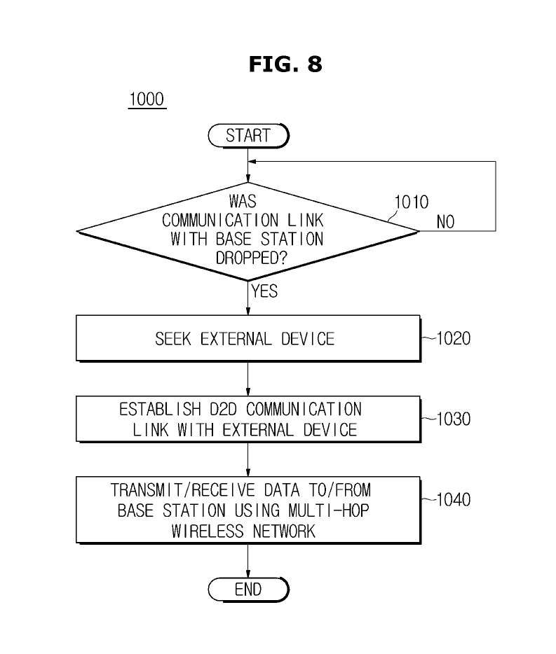

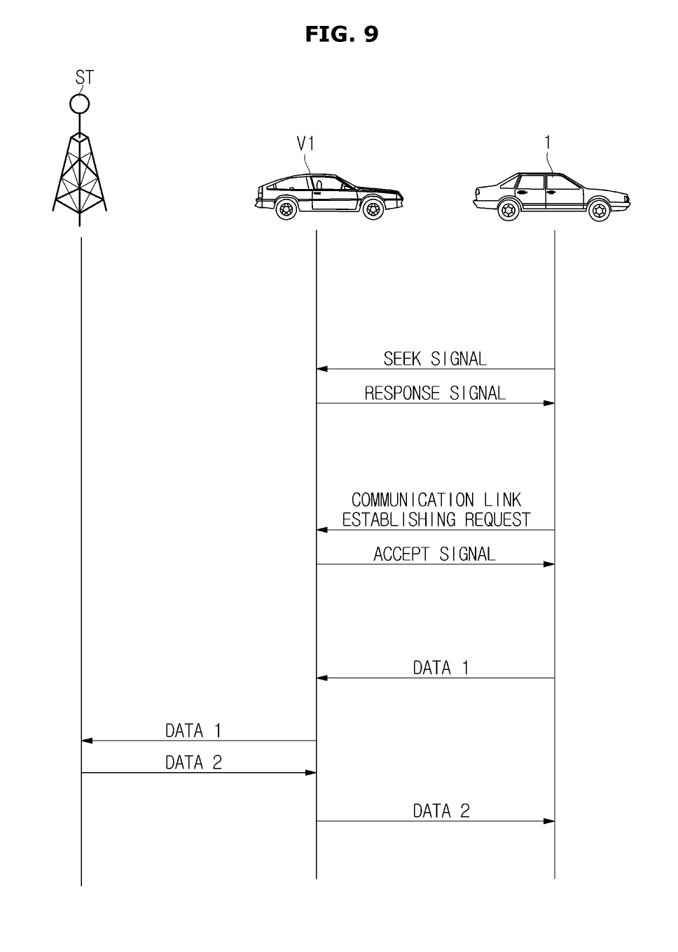

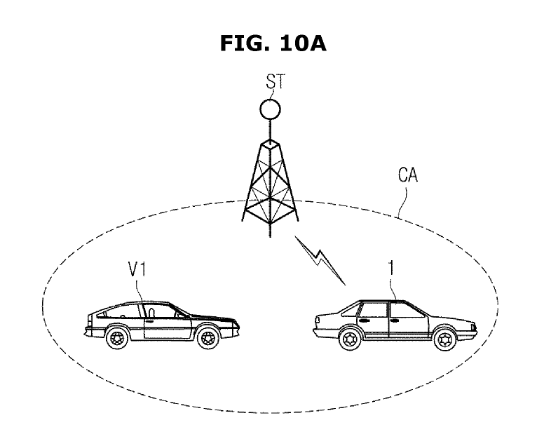

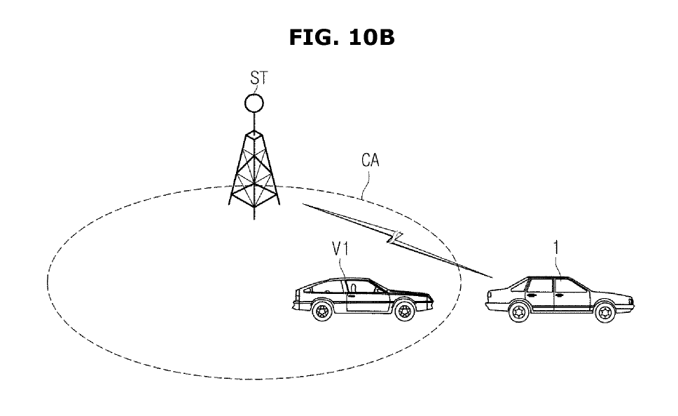

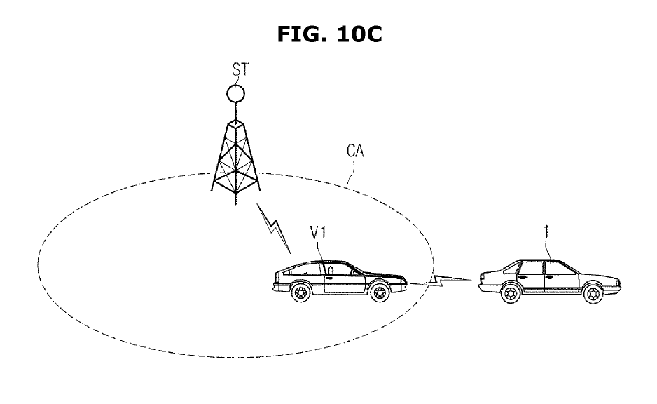

FIGS. 8 and 9 are flowcharts illustrating a method in which the vehicle 1 according to an embodiment of the present disclosure establishes a multi-hop wireless network, and FIGS. 10A, 10B, and 10C are views for describing an example of establishing a multi-hop wireless network according to the method shown in FIGS. 8 and 9.

Referring to FIGS. 8, 9, 10A, 10B, and 10C, a multi-hop communication method 1000 of the vehicle 1 will be described below.

The multi-hop communication method is a communication method of communicating with a base station indirectly through a relay station. The relay station relays communication between a base station and an end point terminal. The relay station may be a small base station having a fixed location, a mobile terminal, or a vehicle.

The vehicle 1 may request another vehicle to perform D2D communication for multi-hop communication. If D2D communication is accepted by the other vehicle, the vehicle 1 may communicate as an end point terminal of a multi-hop network with a base station, and the other vehicle may relay communication between the end point terminal and the base station.

More specifically, the vehicle 1 may determine whether a communication link with a base station ST was dropped, in operation 1010.

A communication link between the vehicle 1 which is running and the base station ST may be dropped for various reasons. For example, when the vehicle 1 departs from a coverage area CA of the base station ST during driving, or when a communication obstacle exists between the base station ST and the vehicle 1, a communication link between the vehicle 1 and the base station ST may be dropped.

For example, as shown in FIG. 10A, the vehicle 1 may communicate with an end point device, such as an external terminal or another vehicle, using a communication link with a base station ST.

When the vehicle 1 moves after a communication link with the base station ST is established, the vehicle 1 may depart from a coverage area CA of the base station ST. As a result, as shown in FIG. 10B, the communication link between the vehicle 1 and the base station ST may be dropped.

In this case, the vehicle 1 may determine whether the communication link with the base station ST was dropped, using one of various methods.

For example, the wireless communication apparatus 200 (see FIG. 3) of the vehicle 1 may estimate communication quality of the base station ST, and determine whether a communication link with the base station ST was dropped, based on the estimated communication quality.

The wireless communication apparatus 200 may estimate communication quality using one of various methods. For example, the wireless communication apparatus 200 may estimate communication quality based on the intensity of a radio signal received from the base station ST, or based on a receiving rate of signals transmitted from the base station ST. More specifically, if the wireless communication apparatus 200 determines that the estimated communication quality is smaller than a reference value, the wireless communication apparatus 200 may determine that the vehicle 1 entered a shadow area SA.

Referring again to FIG. 8, if the vehicle 1 determines that the communication link with the base station ST was not dropped (“No” in operation 1010), the vehicle 1 may continue to communicate with the base station ST.

Also, if the vehicle 1 determines that the communication link with the base station ST was dropped (“Yes” in operation 1010), the vehicle 1 may seek an external device for D2D communication, in operation 1020.

More specifically, the vehicle 1 may transfer a seek signal through the wireless communication apparatus 200, as shown in FIG. 9. If an external device (for example, a mobile terminal or a vehicle) receives the seek signal from the vehicle 1, the external device may transmit a response signal corresponding to the seek signal and identification information for identifying the external device, to the vehicle 1.

For example, if a first vehicle V1 is located around the vehicle 1, as shown in FIG. 10B, the first vehicle V1 may transmit a response signal and identification information of the first vehicle V1 to the vehicle 1, in response to the seek signal from the vehicle 1.

If the vehicle 1 receives the response signal and the identification information, the vehicle 1 may determine that an external device capable of performing D2D communication exists around the vehicle 1, and identify another vehicle. If the vehicle 1 receives no response signal, the vehicle 1 may determine that no external device capable of performing D2D communication exists around the vehicle 1.

Thereafter, the vehicle 1 may establish a D2D communication link with the found external device, in operation 1030.

More specifically, the vehicle 1 may transmit a communication link establishing request to the external device through the wireless communication apparatus 200, as shown in FIG. 9. The external device may receive the communication link establishing request, and transmit an accept signal or a reject signal to the vehicle 1 in response to the communication link establishing request. The external device may determine whether its communication resource can be used for D2D communication with the vehicle 1, and transmit an accept signal or a reject signal to the vehicle 1 according to the result of the determination. If the vehicle 1 receives an accept signal from the other vehicle (that is, the first vehicle V1), a communication link may be established between the vehicle 1 and the first vehicle V1, as shown in FIG. 100. If a communication link is established between the vehicle 1 and the external device, a multi-hop wireless network may be established between the vehicle 1, the external device, and the base station ST.

Thereafter, the vehicle 1 may transmit/receive data to/from the base station ST using the multi-hop wireless network established between the vehicle 1, the external device, and the base station ST, in operation 1040.

More specifically, as shown in FIG. 9, the vehicle 1 may transmit data whose destination is set to the base station ST, to the external device. If the external device receives the data from the vehicle 1, the external device may determine the destination of the data with reference to the header of the data, and then transfer the data to the base station ST.

Also, if the base station ST receives the data from the external device, the base station ST may transmit data whose destination is set to the vehicle 1, to the external device. If the external device receives the data from the base station ST, the external device may determine the destination of the data with reference to the header of the data, and transfer the received data to the vehicle 1.

In this way, the vehicle 1 may transmit/receive data to/from the base station ST using the external device as a relay station. As a result, the vehicle 1 may stably communicate with an end point device, such as an external terminal and another vehicle, through the external device and the base station ST.

Also, since the multi-hop wireless network is established between the vehicle 1, the external device, and the base station ST, a coverage area CA of the base station ST may be widened. Also, the vehicle 1 may relay communication between another vehicle and the base station ST in response to a D2D communication request from the other vehicle for multi-hop communication.

More specifically, if a D2D communication request is received from another vehicle for multi-hop communication, the vehicle 1 may allocate a part of its own communication resource to an operation of relaying communication between the other vehicle and the base station ST. For example, the vehicle 1 may divide time to perform direct communication with the base station ST for a predetermined time period and to relay multi-hop communication between another vehicle and the base station ST for another predetermined time period. Also, the vehicle 1 may divide a frequency to perform direct communication with the base station ST using a predetermined frequency band and to relay multi-hop communication between the other vehicle and the base station ST using another predetermined frequency band. Also, the vehicle 1 may divide a code to perform direct communication with the base station ST using a predetermined code and to relay multi-hop communication between the other vehicle and the base station ST using another predetermined code.

The configurations of the various electronic devices 100 (for example, the wireless communication apparatus 200) included in the vehicle 1 have been described above.

Hereinafter, operations of the various electronic devices 100 included in the vehicle 1 will be described. Specifically, operations of the wireless communication apparatus 200 will be described.

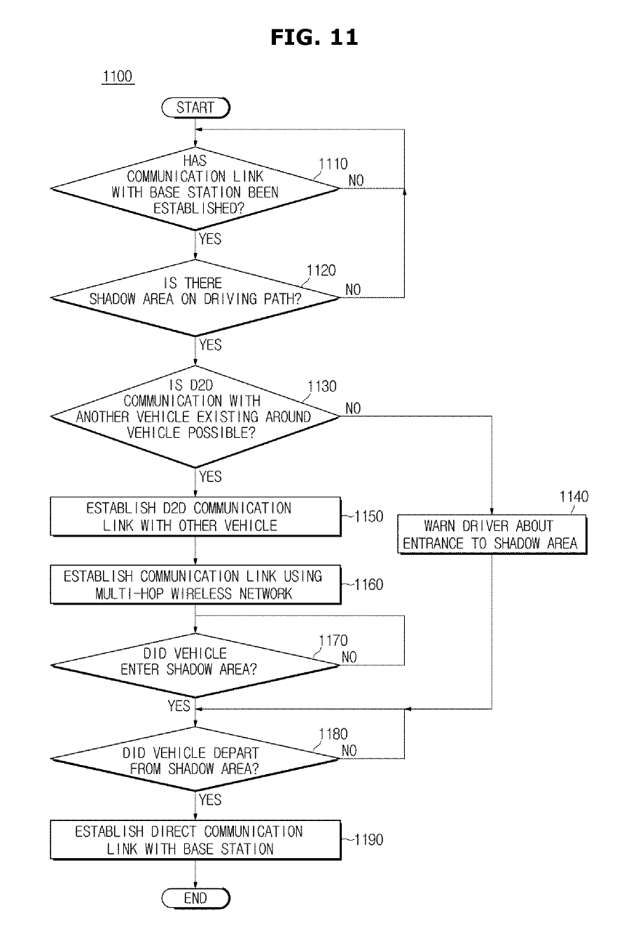

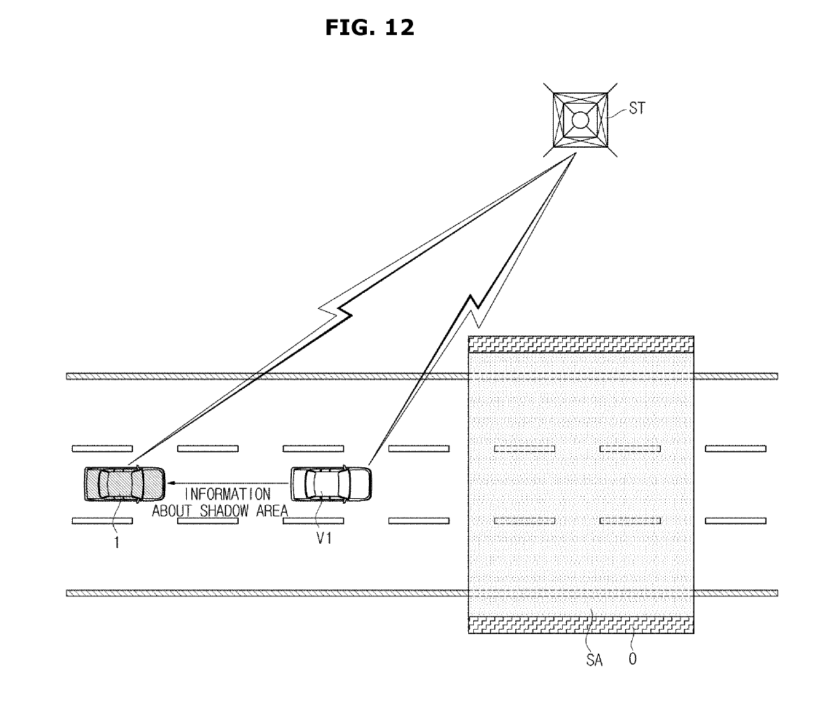

FIG. 11 is a flowchart illustrating an example of a communication method of the vehicle 1 according to an embodiment of the present disclosure, and FIGS. 12, 13, 14, 15, and 16 are views for describing an example of establishing a multi-hop wireless network according to the communication method shown in FIG. 11.

Hereinafter, a communication method 1100 in which the vehicle 1 establishes a multi-hop wireless network using other vehicles V1, V2 and V3 existing around the vehicle 1 as relay stations will be described with reference to FIGS. 11, 12, 13, 14, 15, and 16.

The vehicle 1 may determine whether a communication link with the base station ST has been established, in operation 1110.

The vehicle 1 may communicate with an end point device, such as an external terminal or another vehicle, for various reasons. For example, if a driver instructs communication with a third party or transmits driving information of the vehicle 1 to a server, the vehicle 1 may communicate with another end point device through the communication link with the base station ST.

More specifically, if a driver tries to chat with a third party through a chatting application installed in the AVN system 110 (see FIG. 2), the AVN system 110 may request the wireless communication apparatus 200 to communicate with the third party's end point device through a vehicle communication network NT. At this time, the wireless communication apparatus 200 may establish a communication link with the base station ST in response to the communication request from the AVN system 110.

Also, if an error is generated in the brake system of the vehicle 1, the brake-by-wire system 150 may request the wireless communication apparatus 200 to communicate with an external server (not shown) through the vehicle communication network NT. Then, the wireless communication apparatus 200 may establish a communication link with the base station ST in response to the communication request from the brake-by-wire system 150.

As such, the vehicle 1 may establish a communication link with the base station ST in order to communicate with various end point devices, such as an external device or another vehicle. More specifically, the wireless communication unit 300 of the vehicle 1 may establish a communication link with the base station ST through electronic waves of a pre-allocated frequency.

If no communication link with the base station ST has been established (“No” in operation 1110), the vehicle 1 may continue to perform a current operation.

If a communication link with the base station ST has been already established (“Yes” in operation 1110), the vehicle 1 may determine whether there is a shadow area SA on its driving path, in operation 1120.

Herein, the shadow area S is an area where communication with the base station ST is dropped. For example, the shadow area A may be an area where electric waves from the base station ST are blocked due to a tunnel or obstacle on a road, or an area in which electric waves from the base station ST are blocked for security reasons.

The vehicle 1 may detect the shadow area SA using one of various methods.

For example, as shown in FIG. 12, the vehicle 1 may receive information about a shadow area SA from a first vehicle V1 running ahead. The first vehicle V1 may detect the shadow area SA earlier than the vehicle 1. If the first vehicle V1 detects the shadow area SA, the first vehicle V1 may transmit information about the shadow area SA to the vehicle 1 running behind through D2D communication. The information about the shadow area SA may include information about whether or not a shadow area SA exists, and a distance to a shadow area SA.

If the vehicle 1 receives information about the shadow area SA from the first vehicle V1, the wireless communication apparatus 200 of the vehicle 1 may determine whether the shadow area SA is located on the driving path of the vehicle 1 based on the information about the shadow area SA.

Also, the vehicle 1 may use the AVN system 110 to determine whether a shadow area SA exists on the driving path.

The AVN system 110 may receive information about the shadow area SA from an external server (not shown).

Also, the AVN system 110 may store location information of the shadow area SA, in addition to map data for guiding a path to a destination. A manufacturer of the AVN system 110 may have stored location information of the shadow area SA in advance in the AVN system 110, or the AVN system 100 may store location information of the shadow area SA when the vehicle 1 passes through the shadow area SA.

More specifically, the AVN system 110 may use a Global Positioning System (GPS) receiver (not shown) to acquire location information of the vehicle 1, and determine whether a shadow area SA exists on the driving path of the vehicle 1, based on the location information of the vehicle 1 and location information of the shadow area SA. If the AVN system 110 determines that a shadow area SA exists on the driving path of the vehicle 1, the AVN system 110 may transmit information related to the shadow area SA to the wireless communication apparatus 200 through a vehicle communication network NT. Herein, the information related to the shadow area SA may include information about whether a shadow area SA exists, and a distance to the shadow area SA.

If the wireless communication apparatus 200 receives the information related to the shadow area SA, the wireless communication apparatus 200 may determine whether the shadow area SA is located on the driving path, based on the information related to the shadow area SA.

If the vehicle 1 determines that the shadow area SA is not located on the driving path (“No” in operation 1120), the vehicle 1 may continue to communicate with an end point device, such as an external terminal or another vehicle.

Meanwhile, if the vehicle 1 determines that the shadow area SA is located on the driving path (“Yes” in operation 1120), the vehicle 1 may determine whether D2D communication with another vehicle existing around the vehicle 1 is possible, in operation 1130.

More specifically, the vehicle 1 may transmit a seek signal through the wireless communication apparatus 200. If another vehicle receives the seek signal, the vehicle may transmit a response signal corresponding to the seek signal and identification information for identifying an external device, to the vehicle 1.

Also, the vehicle 1 may determine whether D2D communication with the other vehicle is possible, according to whether a response signal and identification information are received from the other vehicle. More specifically, if the vehicle 1 receives a response signal and identification information from the other vehicle, the vehicle 1 may determine that D2D communication with the other vehicle is possible, and if neither response signal nor identification information are received from the other vehicle, the vehicle 1 may determine that D2D communication with the other vehicle is impossible.

If the vehicle 1 determines that D2D communication with the other vehicle is impossible (“No” in operation 1130), the vehicle 1 may warn a driver about entrance into the shadow area SA, in operation 1140.

For example, the vehicle 1 may display a message representing entrance into the shadow area SA through a display (not shown), a HUD (not shown), or a cluster display (not shown) of the AVN system 110. Also, the vehicle 1 may output a message representing entrance to the shadow area SA through an audio system (not shown) installed therein.

If the vehicle 1 determines that D2D communication with the other vehicle is possible (“Yes” in operation 1130), the vehicle 1 may establish a D2D communication link with the other vehicle V1, V2, or V3, in operation 1150.

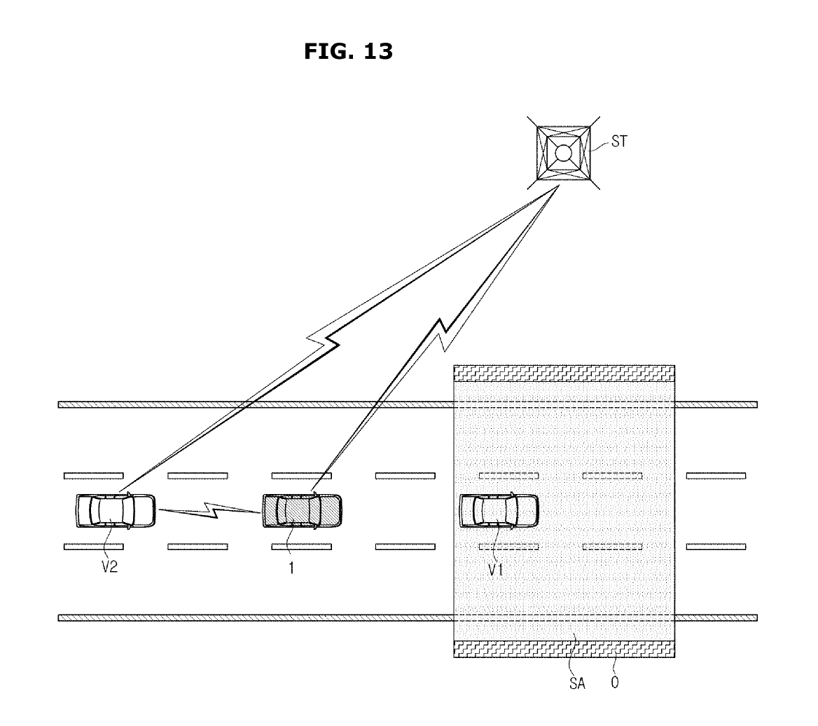

More specifically, the wireless communication apparatus 200 of the vehicle 1 may request the other vehicle V1, V2, or V3 to perform D2D communication through a multi-hop wireless network. For example, the wireless communication apparatus 200 may request a second vehicle V2 that has established a communication link with the base station ST to perform D2D communication, as shown in FIG. 13.

If the second vehicle V2 receives a D2D communication request from the vehicle 1, the second vehicle V2 may determine whether to accept the D2D communication request, according to the state of a communication resource. If the communication resource of the second vehicle V2 is insufficient, the second vehicle V2 may reject the D2D communication request from the vehicle 1. Meanwhile, if the communication resource of the second vehicle V2 is sufficient, the second vehicle V2 may accept the D2D communication request from the vehicle 1.

If the second vehicle V2 accepts the D2D communication request, a communication link between the vehicle 1 and the second vehicle V2 may be established.

Thereafter, the vehicle 1 may establish a communication link with the base station ST using a multi-hop wireless network, in operation 1160.

More specifically, the wireless communication apparatus 200 of the vehicle 1 may request the second vehicle V2 to establish a multi-hop wireless network.

Then, the second vehicle V2 may establish a communication link between the vehicle 1 and the base station ST, in response to the request for establishing the multi-hop wireless network from the vehicle 1.

If a communication link between the vehicle 1 and the base station ST is established through the second vehicle V2, a multi-hop wireless network may be established between the vehicle 1, the second vehicle V2, and the base station ST, as shown in FIG. 13.

As a result, the vehicle 1 may communicate with an end point device, such as an external terminal or another vehicle, through the multi-hop wireless network using the second vehicle V2 as a relay station.

Thereafter, the vehicle 1 may determine whether the vehicle 1 has entered the shadow area SA, in operation 1170.

The AVN system 110 of the vehicle 1 may determine whether the vehicle 1 entered the shadow area SA, based on the location information of the vehicle 1 and the information about the shadow area SA, received by the GPS receiver (not shown), and transmit information about whether the vehicle 1 entered the shadow area SA to the wireless communication apparatus 200 through the vehicle communication network NT.

After the AVN system 110 determines that the vehicle 1 entered the shadow area SA (“Yes” in operation 1170), the AVN system 110 may determine whether the vehicle 1 departed from the shadow area SA, in operation 1180.

More specifically, the AVN system 110 of the vehicle 1 may determine whether the vehicle 1 departed from the shadow area SA, based on the location information of the vehicle 1 and the information about the shadow area SA, received from the GPS receiver (not shown), and transmit information about whether or not the vehicle 1 departed from the shadow area SA to the wireless communication apparatus 200 through the vehicle communication network NT.

After the vehicle 1 entered the shadow area SA, the vehicle 1 may communicate with an end point device, such as an external terminal or another vehicle, through the multi-hop wireless network established between the vehicle 1, the second vehicle V2, and the base station ST.

However, devices constructing the multi-hop wireless network are not limited to the vehicle 1, the second vehicle V2, and the base station ST. In other words, a plurality of relay stations may be provided between the vehicle 1 and the base station ST.

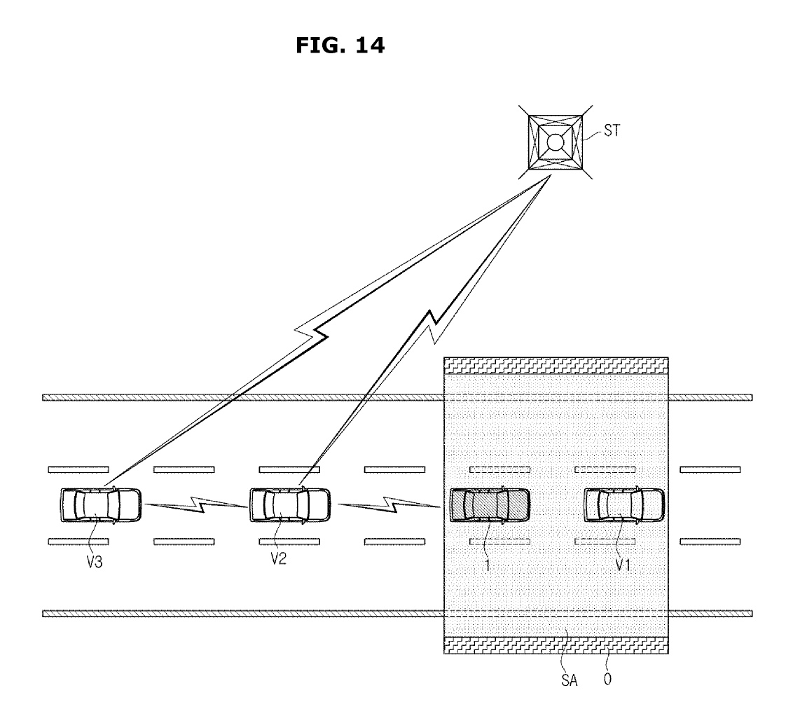

For example, as shown in FIG. 14, a third vehicle V3 running behind the second vehicle V2 may join as a relay station in the multi-hop wireless network.

More specifically, if the vehicle 1 acquires information about the shadow area SA, the vehicle 1 may broadcast the information about the shadow area SA to the first, second, and third vehicles V1, V2, and V3 existing around the vehicle 1. The second vehicle V2 may also receive the information about the shadow area SA transmitted from the vehicle 1.

If the second vehicle V2 receives the information about the shadow area SA, the second vehicle V2 may request the third vehicle V3 to perform D2D communication in order to establish a multi-hop wireless network. If the third vehicle V3 accepts the D2D communication request from the second vehicle V2, a multi-hop wireless network may be established between the second vehicle V2 and the base station ST using the third vehicle V3 as a relay station.

As a result, the multi-hop wireless network may be expanded to include the vehicle 1, the second vehicle V2, the third vehicle V3, and the base station ST, as shown in FIG. 14.

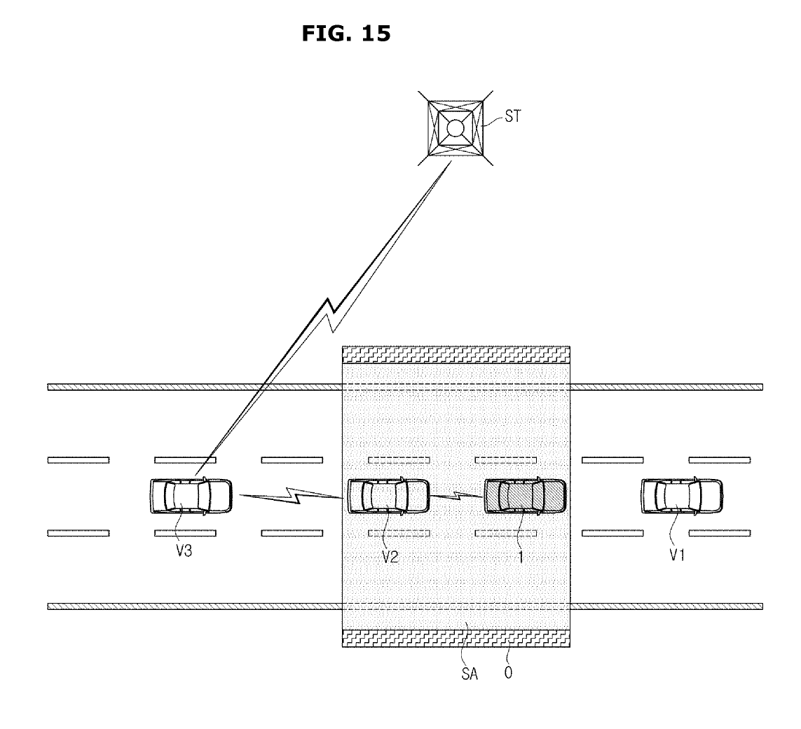

Also, as shown in FIG. 15, if the second vehicle V2 entered the shadow area SA, the vehicle 1 may communicate with an end point terminal, such as an external terminal or another vehicle, through the multi-hop wireless network using the second vehicle V2 and the third vehicle V3 as relay stations.

If it is determined that the vehicle 1 departed from the shadow area SA (“Yes” in operation 1180), the vehicle 1 may establish a direct communication link with the base station ST, in operation 1190.

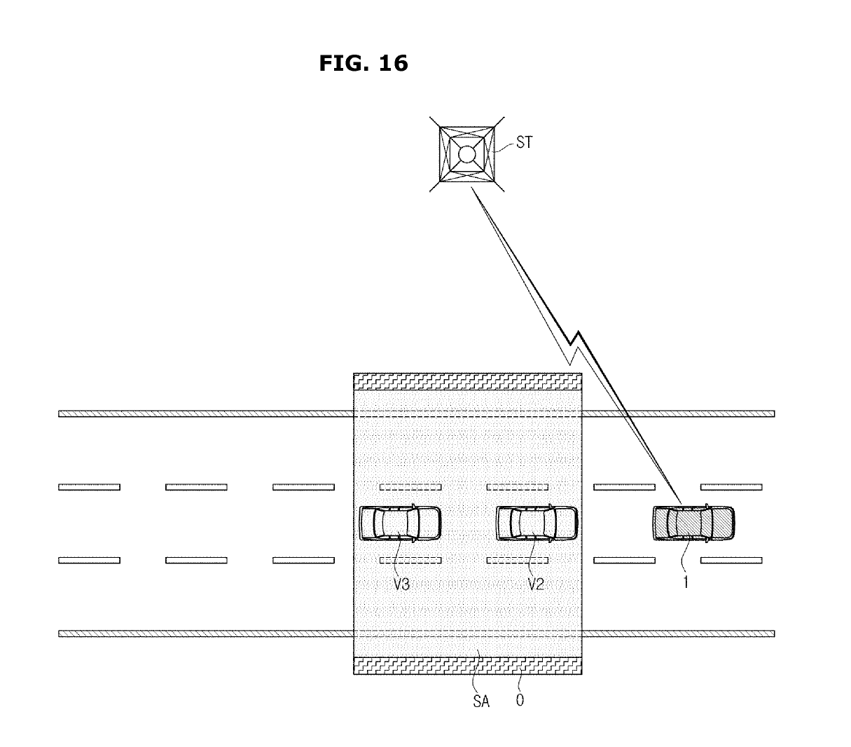

If the vehicle 1 departed from the shadow area SA, the vehicle 1 may establish a direct communication link with the base station ST. Accordingly, the vehicle 1 may establish a communication link with the base station ST, and terminate communication with the second vehicle V2, as shown in FIG. 16.

As a result, the vehicle 1 may communicate with an external terminal or another vehicle through the base station ST.

As described above, if the vehicle 1 detects a shadow area SA during communication, the vehicle 1 may establish a multi-hop wireless network using D2D communication with other vehicles V1, V2, and V3 existing around the vehicle 1, and establish a communication link with the base station ST using the multi-hop wireless network.

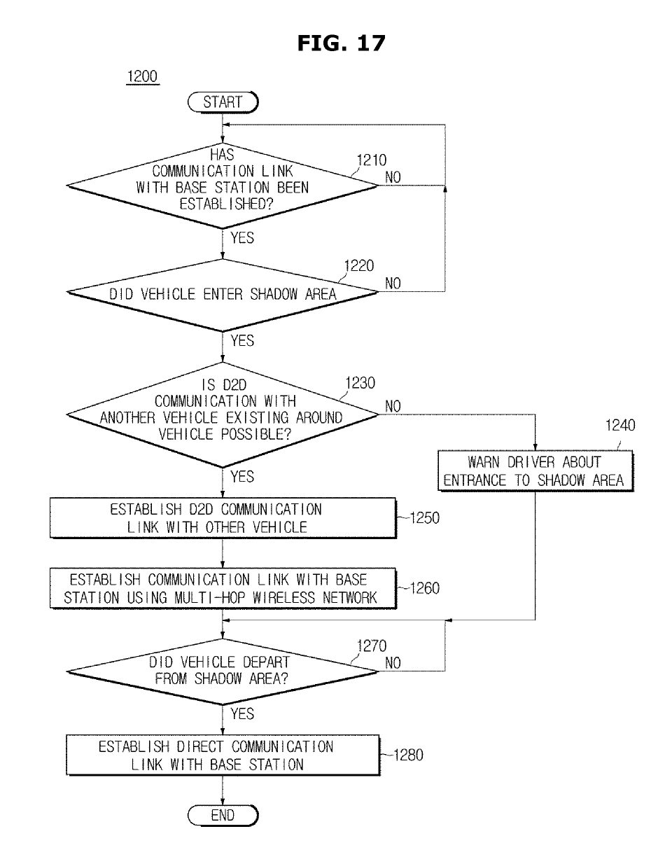

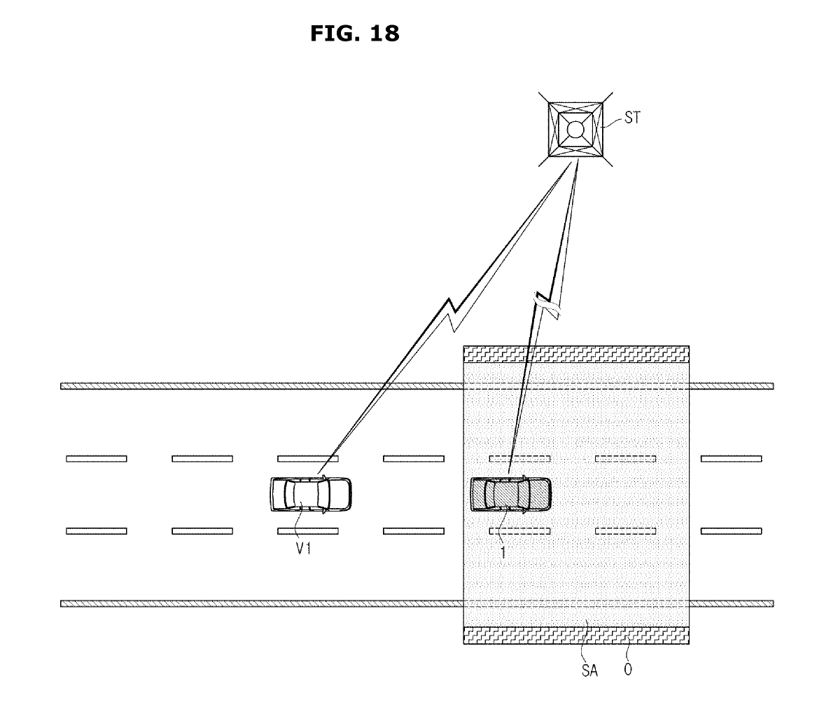

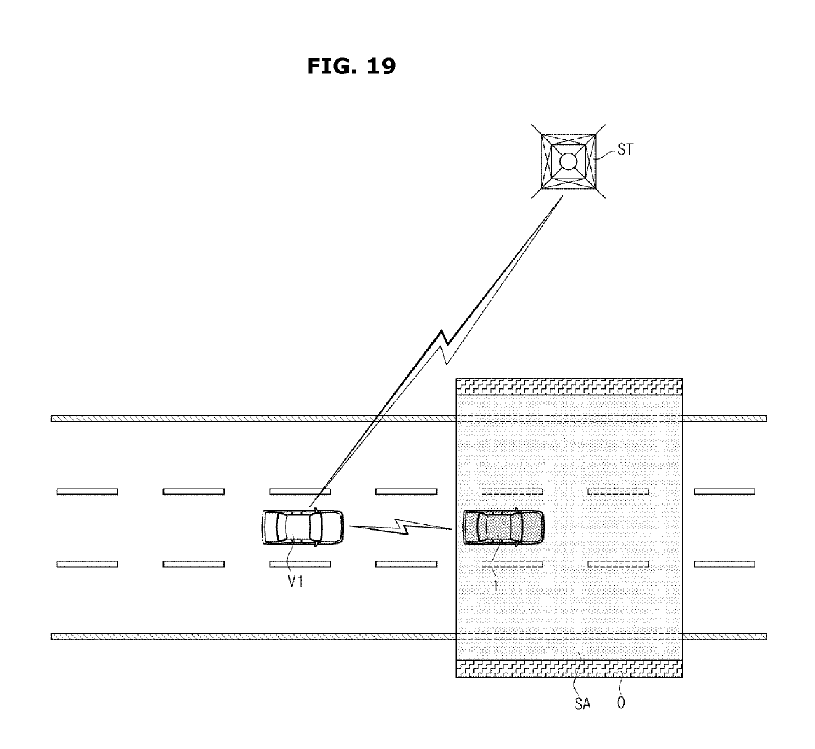

FIG. 17 is a flowchart illustrating another example of a communication method of the vehicle 1 according to an embodiment of the present disclosure, and FIGS. 18 and 19 are views for describing an example of establishing a multi-hop wireless network according to the communication method shown in FIG. 17.

Hereinafter, a communication method 1200 in which the vehicle 1 establishes a multi-hop wireless network using other vehicles V1, V2, and V3 existing around the vehicle 1 as relay stations will be described with reference to FIGS. 17, 18, and 19.

The vehicle 1 may determine whether a communication link with a base station ST has been established, in operation 1210.

The vehicle 1 may communicate with an end point device, such as an external terminal or another vehicle, for various reasons. For example, if a driver instructs communication with a third party or transmits driving information of the vehicle 1 to a server, the vehicle 1 may communicate with another end point device through the communication link with the base station ST.

More specifically, if a driver tries to chat with a third party through a chatting application installed in the AVN system 110 (see FIG. 2), the AVN system 110 may request the wireless communication apparatus 200 to communicate with the third party's end point device through a vehicle communication network NT. At this time, the wireless communication apparatus 200 may establish a communication link with the base station ST, in response to the communication request from the AVN system 110.

Also, if an error is generated in the brake system of the vehicle 1, the brake-by-wire system 150 may request the wireless communication apparatus 200 to communicate with an external server (not shown) through the vehicle communication network NT. Then, the wireless communication apparatus 200 may establish a communication link with the base station ST, in response to the communication request from the brake-by-wire system 150.

As such, the vehicle 1 may establish a communication link with the base station ST in order to communicate with various end point devices, such as an external terminal or another vehicle. More specifically, the wireless communication unit 300 of the vehicle 1 may establish a communication link with the base station ST through electronic waves of a pre-allocated frequency.

If no communication link with the base station ST has been established (“No” in operation 1210), the vehicle 1 may continue to perform current operations.

If a communication link with the base station ST has been already established (“Yes” in operation 1210), the vehicle 1 may determine whether the vehicle 1 has entered a shadow area SA, in operation 1220.

The vehicle 1 may determine whether the vehicle 1 has entered the shadow area SA using one of various methods.

For example, the wireless communication apparatus 200 (see FIG. 3) of the vehicle 1 may estimate communication quality of the base station ST, and determine whether the vehicle 1 entered a shadow area SA, based on the estimated communication quality.

The wireless communication apparatus 200 may estimate communication quality using one of various methods. For example, the wireless communication apparatus 200 may estimate communication quality based on the intensity of a radio signal received from the base station ST, or based on a receiving rate of signals transmitted from the base station ST.

More specifically, if the wireless communication apparatus 200 determines that the estimated communication quality is smaller than a reference value, the wireless communication apparatus 200 may determine that the vehicle 1 entered a shadow area SA.

If the vehicle 1 determines that the vehicle 1 entered no shadow area SA (“No” in operation 1220), the vehicle 1 may continue to communicate with the base station ST.

Meanwhile, if the vehicle 1 determines that the vehicle 1 entered a shadow area SA (“Yes” in operation 1220), the vehicle 1 may determine whether D2D communication with another vehicle existing around the vehicle 1 is possible, in operation 1230.

More specifically, the vehicle 1 may transmit a seek signal using the wireless communication apparatus 200. If another vehicle receives the seek signal, the vehicle may transmit a response signal corresponding to the seek signal and identification information for identifying an external device, to the vehicle 1.

Also, the vehicle 1 may determine whether D2D communication with the other vehicle is possible, according to whether a response signal and identification information are received from the other vehicle. More specifically, if the vehicle 1 receives a response signal and identification information from the other vehicle, the vehicle 1 may determine that D2D communication with the other vehicle is possible, and if neither response signal nor identification information are received from the other vehicle, the vehicle 1 may determine that D2D communication with the other vehicle is impossible.

If the vehicle 1 determines that D2D communication with the other vehicle is impossible (“No” in operation 1230), the vehicle 1 may warn a driver about entrance to the shadow area SA, in operation 1240.

For example, the vehicle 1 may display a message representing entrance to the shadow area SA through a display (not shown), a HUD (not shown), or a cluster display (not shown) of the AVN system 110. Also, the vehicle 1 may output a message representing entrance to the shadow area SA through an audio system (not shown) installed therein.

If the vehicle 1 determines that D2D communication with the other vehicle is possible (“Yes” in operation 1230), the vehicle 1 may establish a D2D communication link with the other vehicle V1, V2, or V3, in operation 1250.

If the vehicle 1 entered the shadow area SA, a communication link between the vehicle 1 and the base station SA may be dropped, as shown in FIG. 18. Then, the vehicle 1 may request another vehicle (for example, the first vehicle V1) existing around the vehicle 1 to perform D2D communication in order to establish a multi-hop wireless network using the other vehicle as a relay station.

For example, the wireless communication apparatus 200 may request the first vehicle V1 which has established a communication link with the base station ST to perform D2D communication.

If the first vehicle V1 receives the D2D communication request from the vehicle 1, the first vehicle V1 may determine whether to accept the D2D communication request, according to the state of a communication resource. If the communication resource of the first vehicle V1 is insufficient, the first vehicle V1 may reject the D2D communication request from the vehicle V1. Meanwhile, if the communication resource of the first vehicle V1 is sufficient, the first vehicle V1 may accept the D2D communication request from the vehicle V1.

If the first vehicle V1 accepts the D2D communication request, a D2D communication link between the vehicle 1 and the first vehicle V1 may be established.

Thereafter, the vehicle 1 may establish a communication link with the base station ST using the multi-hop wireless network, in operation 1260.

More specifically, the wireless communication apparatus 200 of the vehicle 1 may request the first vehicle V1 to establish a multi-hop wireless network. Then, the first vehicle V1 may establish a communication link between the vehicle 1 and the base station ST, in response to the request for establishing the multi-hop wireless network from the vehicle 1.

If a communication link is established between the vehicle 1 and the base station ST through the first vehicle V1, a multi-hop wireless network may be established between the vehicle 1, the first vehicle V1, and the base station ST, as shown in FIG. 19.

As a result, the vehicle 1 may communicate with an end point device, such as an external terminal or another vehicle, through the multi-hop wireless network using the first vehicle V1 as a relay station.

Thereafter, the vehicle 1 may determine whether the vehicle 1 has departed from the shadow area SA, in operation 1270.

The vehicle 1 may determine whether the vehicle 1 has departed from the shadow area SA using one of various methods.

For example, the wireless communication apparatus 200 of the vehicle 1 may estimate communication quality of the base station ST, and determine whether the vehicle 1 departed from the shadow area SA, based on the estimated communication quality.

Herein, the wireless communication apparatus 200 may estimate communication quality using one of various methods. For example, the wireless communication apparatus 200 may estimate communication quality based on the intensity of a radio signal received from the base station ST, or based on a receiving rate of signals transmitted from the base station ST.

More specifically, if the wireless communication apparatus 200 determines that the estimated communication quality is smaller than a reference value, the wireless communication apparatus 200 may determine that the vehicle 1 departed from the shadow area SA.

If it is determined that the vehicle 1 departed from the shadow area SA (“Yes” in operation 1270), the vehicle 1 may establish a direct communication link with the base station ST, in operation 1280.

If the vehicle 1 departed from the shadow area SA, the vehicle 1 may establish a direct communication link with the base station ST. Accordingly, the vehicle 1 may establish a communication link with the base station ST, and terminate D2D communication with the first vehicle V1.

As a result, the vehicle 1 may communicate with an external terminal or another vehicle through the base station ST.

As described above, if the vehicle 1 entered the shadow area SA during communication, the vehicle 1 may establish a multi-hop wireless network using D2D communication with another vehicle V1, V2, or V3 existing around the vehicle 1, and establish a communication link with the base station ST using the multi-hop wireless network.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
a wireless communication unit for performing communication with an external device through a first communication link established with a base station; and
a controller for controlling, if a shadow area is detected, the wireless communication unit to establish a second communication link with the base station through a multi-hop wireless network established with another vehicle existing around the vehicle.

2. The vehicle according to claim 1, further comprising an Audio/Video/Navigation (AVN) system for acquiring location information of the shadow area,
wherein the controller determines whether the shadow area is located on a driving path of the vehicle based on the location information of the shadow area received from the AVN system.

3. The vehicle according to claim 2, wherein the location information of the shadow area is received from an external server.

4. The vehicle according to claim 2, wherein the location information of the shadow area is stored in advance in the AVN system.

5. The vehicle according to claim 1, wherein the controller determines whether the shadow area is located on a driving path of the vehicle based on information related to the shadow area received from another vehicle running ahead through the wireless communication unit.

6. The vehicle according to claim 1, wherein the controller determines that the vehicle is located within the shadow area if the intensity of a radio signal received from the base station is smaller than a predetermined reference value.

7. The vehicle according to claim 1, wherein if the shadow area is detected, the controller controls the wireless communication unit to request the other vehicle existing around the vehicle to perform Device-to-Device (D2D) communication.

8. The vehicle according to claim 7, wherein the controller controls the wireless communication unit to establish a multi-hop wireless network using the D2D communication.

9. The vehicle according to claim 1, wherein the controller establishes the first communication link with the base station if the intensity of a radio signal received from the base station is greater than a predetermined reference value.

10. A communication method of a vehicle, comprising:
performing communication with an external device through a first communication link established with a base station;
detecting a shadow area; and
establishing, if the shadow area is detected, a second communication link with the base station through a multi-hop wireless network established with another vehicle existing around the vehicle.

11. The communication method according to claim 10, wherein the step of detecting a shadow area comprises determining whether the shadow area is located on a driving path of the vehicle based on location information of the shadow area received from an Audio/Video/Navigation (AVN) system storing the location information of the shadow area.

12. The communication method according to claim 10, wherein the step of detecting a shadow area comprises determining whether the shadow area is located on a driving path of the vehicle based on information related to the shadow area received from another vehicle running ahead through the wireless communication unit.

13. The communication method according to claim 10, wherein the step of detecting a shadow area comprises determining that the vehicle is located within the shadow area if the intensity of a radio signal received from the base station is smaller than a predetermined reference value.

14. The communication method according to claim 10, wherein the step of establishing a second communication link with the base station comprises requesting, if the shadow area is detected, the other vehicle existing around the vehicle to perform Device-to-Device (D2D) communication.

15. The communication method according to claim 14, wherein the step of establishing a second communication link with the base station further comprises establishing a multi-hop wireless network using the D2D communication.

16. The communication method according to claim 10, further comprising establishing the first communication link with the base station if the intensity of a radio signal received from the base station is greater than a predetermined reference value.

17. A wireless communication apparatus for vehicle, comprising:
a wireless communication unit for performing communication with an external device through a first communication link established with a base station; and
a controller for controlling, if a shadow area is detected, the wireless communication unit to establish a second communication link with the base station through a multi-hop wireless network established with another vehicle existing around the vehicle.

18. The wireless communication apparatus according to claim 17, wherein the controller determines whether the shadow area is located on a driving path of the vehicle, based on location information of the shadow area received from an Audio/Video/Navigation (AVN) system storing the location information of the shadow area.

19. The wireless communication apparatus according to claim 18, wherein the location information of the shadow area is received from an external server.

20. The wireless communication apparatus according to claim 18, wherein the location information of the shadow area is stored in advance in the AVN system.

21. The wireless communication apparatus according to claim 17, wherein the controller determines whether the shadow area is located on a driving path of the vehicle based on information related to the shadow area received from another vehicle running ahead through the wireless communication unit.

22. The wireless communication apparatus according to claim 17, wherein the controller determines that the vehicle is located within the shadow area if the intensity of a radio signal received from the base station is smaller than a predetermined reference value.

23. The wireless communication apparatus according to claim 17, wherein if the shadow area is detected, the controller controls the wireless communication unit to request the other vehicle existing around the vehicle to perform Device-to-Device (D2D) communication.

24. The wireless communication apparatus according to claim 23, wherein the controller controls the wireless communication unit to establish a multi-hop wireless network using the D2D communication.

25. The wireless communication apparatus according to claim 17, wherein the controller establishes the first communication link with the base station if the intensity of a radio signal received from the base station is greater than a predetermined reference value.
